(19) United States
(12) Patent Application Publication
(10) Pub. No.: US 2004/0176970 A1
(43) Pub. Date: Sep. 9, 2004

(54) Method and system for space travel using a lottery

(76) Inventors: Michael A Paluszek, Princeton, NJ (US); James a Frueh, Trenton, NJ (US)

Correspondence Address: Richard C Woodbridge, Synnestvedt Lechner & Woodbridge, P O Box 592, Princeton, NJ, 08542-0592, US

(21) Appl. No.: 10/478,522

(22) PCT Filed: May 21, 2002
(86) PCT No.: PCT/US02/16079

Related U.S. Application Data
(60) Provisional application No. 60/292,354, filed on May 21, 2001.

(51) Int. Cl. G06F 17/60

(52) U.S. Cl. 705/1

(57) ABSTRACT

A method and system for generating funds to allow tourists to fly in space. A customer buys a lottery ticket (14), which gives the customer the chance to fly in space should the ticket be selected. The revenue generated by the lottery pays for the training of the customer and the launch and flight costs for the customer. Customers may optionally enroll in a training class (26) that qualifies (22) the tourist for flight. Customers who do so are given a greater chance of winning future lotteries. In each lottery a number of customers greater than the number of available flight slots are selected. All receive flight training (38). Customers who receive training may enter future lotteries (42) and would have a greater chance of winning, just as those who pay for training have a greater chance of winning. Customers who cannot meet the physical standards are disqualified. The lottery is conducted both on the Internet and also using existing lottery ticket systems.

### CROSS REFERENCE TO RELATED APPLICATIONS

This application claims the priority of Provisional U.S. Application Serial No. 60/292,354 filed on May 21, 2001 and entitled LOTTERY BASED SPACE TOURISM by Michael A. Paluszek and James A. Frueh, the entire contents and substance of which are hereby incorporated in total by reference.

### BACKGROUND OF THE INVENTION

1. Field of the Invention

This invention relates to the field of the finding of human spaceflight.

2. Description of Related Art

This invention relates to a method and system for paying for human space travel by means of a lottery.

Until recently, human space travel has been limited to test pilots and specially trained scientists. In the last two years space tourism has become a possibility, albeit a prohibitively expensive possibility. The recent examples of space tourism are the flight of Senator John Glenn, Mr. Dennis Tito and Mark Shuttlewotth from South Africa. In the former case the cost was subsidized by the U.S. Government. In the latter cases, the cost was $20 million dollars for a flight to the International Space Station on a Russian Soyuz vehicle and a short stay on the Space Station.

Lotteries are frequently used by governments to pay for services that would otherwise require taxes. In these cases the prizes are money. Similarly, sweepstakes are used to generate business for commodities such as magazines. In general the sweepstakes is a method of advertising. The winner receives a prize unrelated to the advertised business.

Building launch vehicles specifically for civilian space travelers has been contemplated. One company proposed a module for the U.S. Space Shuttle that would carry 100 people into space. This would bring the recurring cost to $2.5 million per person just for the flight. However, the capital costs would be in excess of $1 billion to build such a module and the refurbishment costs would also be large making it difficult to operate such a module profitably at the prices charged for current space tourists.

A need exists for a practical solution for reducing the cost of spaceflight to a level to enable civilians to fly routinely into space.

### SUMMARY OF THE INVENTION

Briefly described, the invention comprises a lottery for civilians to fly in space without requiring government sponsorship. The lottery generates revenue, which is used to pay for the spaceflight, expenses of the business and generate profits. It is contemplated that revenue would be reinvested to increase the number of flights by expanding the destinations and increasing the number of available flights. This would provide sustainable, stable growth.

### BRIEF DESCRIPTION OF THE DRAWINGS

FIG. 1 shows the first part of the process flow for the lottery.

FIG. 2 shows the second part of the process flow for the lottery.

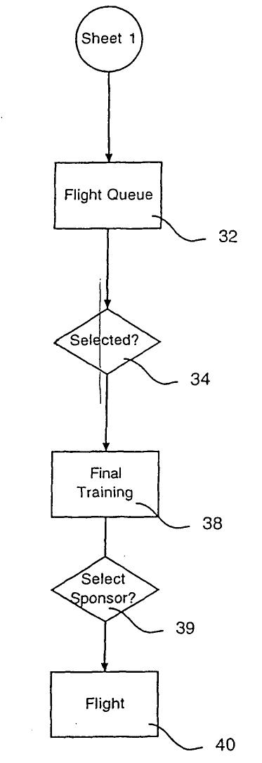

FIG. 3 shows the revenue flow.

### DESCRIPTION OF THE PREFERRED EMBODIMENT

During the course of this description like numbers will be used to identify like elements according to the different views, which illustrate the invention.

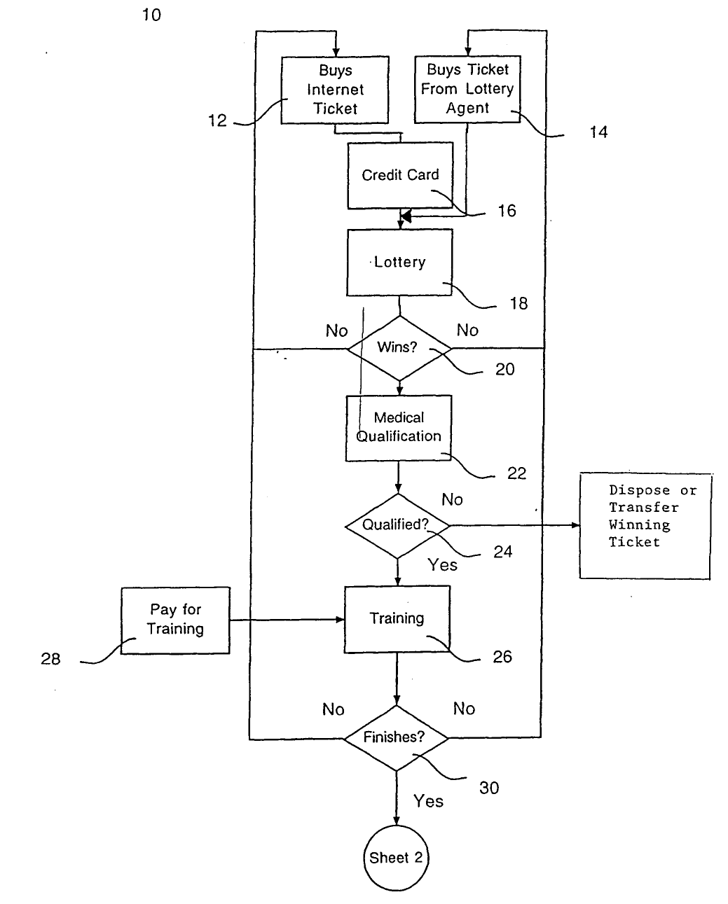

In the embodiment of the invention depicted in FIG. 1 a lottery 18 is conducted over the Internet 12 whereby the customers pay for chance(s) to fly in space using a credit card 16. The lottery could also be conducted through existing lottery systems 14. The customers are guaranteed an opportunity to fly as long as the customer is physically capable and available for the designated flight. If the customer wins 20, the customer undergoes a medical evaluation 22. If the customer passes 24, the customer then undergoes flight-training 26. The lottery retains the right to refuse 24 to fly an individual if the individual is not physically able to fly or cannot take the time for the required training. In which case, various means are contemplated to potentially compensate such an unqualified winner, to include, but not be limited to, return of the purchase price of his lottery ticket, a consolation prize, a cash buy out of his winning ticket, or permitting the individual to transfer the ticket to another individual by gift or sale.

An additional embodiment of the invention helps customers assess their suitability for space flight by presenting information on a central server. That is, physical requirements and acceptable medical test parameters would be available from the server. In addition, online training courses would be offered. The invention envisions that additional training would take place at regional training centers.

In an alternative embodiment potential customers may also pay for training 28 at a training location. In which case they receive a bonus in the form of a higher probability of winning the lottery. In one embodiment, this higher probability is obtained by awarding the participant additional lottery chances (for example, 100 lottery tickets) upon successful completion of this training 30.

Once an individual has won the lottery and has successfully completed this training and medical qualification, the customer is placed in the flight queue 32 in the order in which the customers winning ticket was selected. When the customer is selected for an actual flight 34, the customer receives final training 38. When the flight becomes available 40, the customer flies in space. In an additional embodiment the customer can optionally 39 choose to wear an advertising logo or product or perform tasks for commercial organizations that want to perform research or other work in space. This service is provided via the space lottery. The customer would be paid for this participation and the lottery would be paid a fee by the commercial organization 41.

The lottery 18 allows for a totally automated collection of funds using credit cards 16 thus minimizing business expenses.

The arrangement with the launch provider 26 would be to guarantee to pay the incremental cost of adding the civilian to a flight. All additional revenue would be split between the launch provider and business. This would maximize the incentive to the launch provider in that it would provide the launch provider with added revenue at no cost to the launch provider and minimal risk.

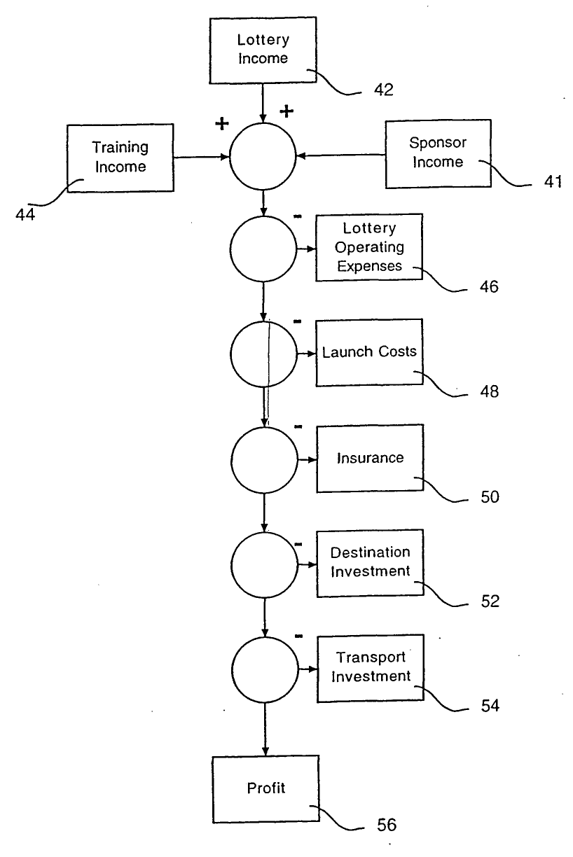

The invention 10 has several distinct advantages over prior art business models. The revenue flow is shown in FIG. 3. The primary income source is from the lottery 42. An additional revenue source, training income 44, is provided in the embodiment discussed above where individuals can obtain training prior to winning the lottery. Yet another source of income is moneys obtain by sponsors 41.

The costs are the expenses of operating the lottery 46 including marketing, advertising, telecommunications costs, and server operation. Insurance must be purchased 48 both to cover injury to the customer and to cover the possibility that the revenue generated by a given lottery is insufficient to pay launch costs. One embodiment of the invention contemplates awarding the lottery winner with sufficient money to cover applicable taxes for the spaceflight prize. Thus for example, the launch company would set a value on the spaceflight (perhaps, the price it would charge non-lottery passengers). The value of the corresponding taxes could then be paid directly to the individual or sent directly to the taxing jurisdiction.

Currently, launch costs are $20 million per customer on a Russian Soyuz spacecraft. Given a ticket price of $10, this requires only 2 million lottery tickets. Two additional expense items noted in FIG. 3 are destination expense 50 and transport development 54. Both are required to provide for revenue growth. The initial destination investment 52 would be for a civilian module on the International Space Station to accommodate 10-20 guests and staff. The initial transport expense would be for a reusable two-stage to orbit vehicle that could carry 20 customers and fly biweekly. Note that it is not economically feasible to design or build such vehicles and destinations without the large customer base and revenue base which are both generated by the lottery provided by the present invention. There are no launch vehicles, except possibly Orbital Sciences Corporation's Pegasus, that have not been capitalized by government funding.

Revenue growth requires that increasing numbers of civilians participate in the lottery, that they be willing to pay higher prices for tickets and that the cost of flying each civilian decreases. This system provides for this by reinvesting revenues specifically into increasing the number of flight opportunities to potential customers. This is done by increasing the number of launch opportunities with existing vehicles; increasing the capacity of tourist facilities in orbit; developing new tourist vehicles; and expanding the available destinations. The latter requires new vehicles with the capability to leave earth orbit. The advantage of this model is that it would sustain customer interest over an extended period of time as the capabilities increase. This is similar to the approach taken by state lottery systems which merge lotteries to increase the dollar amount of the winnings, thus increasing sales and revenues.

While the invention has been described with reference to the preferred embodiment thereof it will be appreciated by those of ordinary skill in the art that modifications can be made to the parts that comprise the invention without departing from the spirit and scope thereof.

1. A method for generating revenue for individuals to fly in space, the method comprising:
conducting a lottery wherein lottery chances are sold to customers and one or more winners are awarded a slot on a spaceflight.

2. The method of claim 1 wherein the lottery is conducted over the Internet by means of credit card purchases of lottery tickets.

3. The method of claim 1 wherein the lottery is conducted using existing lottery systems used for state and national lotteries.

4. The method of claim 1 wherein the number of winners is greater than the number of spaceflight slots and all winners receive flight training.

5. The method of claim 1 wherein winners are reimbursed for applicable income taxes pertaining to the slot on a spaceflight.

6. The method of claim 1 wherein the winners are required to be medically tested in order to be medically qualified for the spaceflight.

7. The method of claim 1 further comprising a training step to qualify individuals for spaceflight.

8. The method of claim 7 wherein individuals are permitted to pay to undergo the training prior to winning the lottery.

9. The method of claim 8 wherein a customer has a probability of being a lottery winner and further wherein an individual who has undergone the training would be awarded a greater probability of being a lottery winner.

10. The method of claim 1 further comprising a revenue growth system wherein revenue is used to increase the number of flight opportunities thus expanding tourist interest and expanding revenue.

11. The revenue growth system of claim 10 wherein revenue is used to secure additional launch opportunities with existing launch vehicles.

12. The revenue growth system of claim 11 wherein revenue is used to expand the capacity of on-orbit tourist facilities.

13. The revenue growth system of claim 12 wherein revenue is used to build new tourist vehicles.

14. The revenue growth system of claim 13 wherein revenue is used to make available new space tourist destinations.

15. A system for conducting a lottery for generating revenue for individuals to fly in space comprising:
one or more lottery distribution locations;
a medical testing facility; and,
a spaceflight training facility.

16. The system of claim 15 wherein said one or more lottery distribution locations comprises an Internet facility.

17. The system of claim 16 wherein an individual's payment for participation in the lottery is by credit card.

18. The system of claim 15 wherein said medical testing facility comprises an Internet facility.

19. The system of claim 15 wherein said spaceflight training facility comprises an Internet facility.
